(19) United States
(12) Patent Application Publication
(10) Pub. No.: US 2016/0014233 A1
(43) Pub. Date: Jan. 14, 2016

(54) COMPUTER-IMPLEMENTED AGENT TRANSFER

(71) Applicant: Google Inc., Mountain View, CA (US)

(72) Inventors: Johnny Chen, Sunnyvale, CA (US); Thomas L. Dean, Los Altos Hills, CA (US); Gabriel Schine, San Francisco, CA (US); Peter Lau, Mountain View, CA (US); Sudeep Gandhe, Mountain View, CA (US)

(21) Appl. No.: 14/325,507

(22) Filed: Jul. 8, 2014

(51) Int. Cl. H04L 29/06; H04L 29/08

(52) U.S. Cl. CPC H04L 67/42; H04L 67/14; H04L 67/26

(57) ABSTRACT

Methods, systems, and apparatus, including computer programs encoded on computer storage media, for associating a computer-implemented agent with another device. One of the methods includes associating a computer-implemented agent, which was previously associated with a first device, with a second device, determining, by the computer-implemented agent, first data representing one or more properties of the first device, determining, by the computer-implemented agent, second data representing one or more properties of the second device, comparing, by the computer implemented agent, the first data and the second data to determine differences between the properties of the first device and the properties of the second device, and providing, by the computer-implemented agent to a user of the second device, a presentation of one or more of the differences between the properties of the first device and the properties of the second device.

### BACKGROUND

This specification relates to transferring a computer-implemented agent from one device to another.

A computer-implemented agent may interact with a user to provide the user with an interface for features of a device on which the computer-implemented agent executes or with which the computer-implemented agent is associated. For example, a computer-implemented agent may execute on a mobile device, receive voice input from a user, and execute one or more actions in response to the voice input, such as retrieving search results responsive to the voice input and providing the search results to the user.

### SUMMARY

In general, one innovative aspect of the subject matter described in this specification can be embodied in methods that include the actions of associating a computer-implemented agent, which was previously associated with a first device, with a second device, determining, by the computer-implemented agent, first data representing one or more properties of the first device, determining, by the computer-implemented agent, second data representing one or more properties of the second device, comparing, by the computer implemented agent, the first data and the second data to determine differences between the properties of the first device and the properties of the second device, and providing, by the computer-implemented agent to a user of the second device, a presentation of one or more of the differences between the properties of the first device and the properties of the second device. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. a computer representation of the computer implemented agent may include user history information that indicates user interactions with the first device. Comparing the first data and the second data to determine the differences between the properties of the first device and the properties of the second device may include determining, using the user history information, the properties of the second device that are different from the properties of the first device and that are most likely to be used by the user of the second device, and providing, by the computer implemented agent to the user of the second device, a presentation of the properties of the second device that are different from the properties of the first device and that are most likely to be used by the user. The method may include prompting, by the computer implemented agent, the user of the second device to download an application in response to determining the properties of the second device that are different from the properties of the first device and that are most likely to be used by the user of the second device.

In some implementations, comparing the first data and the second data to determine the differences between the properties of the first device and the properties of the second device may include comparing the first data and the second data to determine hardware differences between the first device and the second device. Comparing the first data and the second data to determine the differences between the properties of the first device and the properties of the second device may include comparing the first data and the second data to determine applications or settings available on the second device that were not available on the first device. Comparing the first data and the second data to determine the differences between the properties of the first device and the properties of the second device may include comparing the first data and the second data to determine different functionality available to the computer implemented agent when associated with the second device that was not available to the computer implemented agent when the computer implemented agent was associated with the first device.

In some implementations, associating the computer implemented agent, which was previously associated with the first device, with the second device may include changing, by a server, an assignment of the computer implemented agent from the first device to the second device, and executing, by the server, the computer implemented agent after the computer implemented agent is associated with the second device. The method may include receiving, by the server prior to associating the computer implemented agent with the second device, a message from the first device that identifies the first device and the second device and indicates that the server should associate the computer implemented agent with the second device, wherein associating the computer implemented agent, which was previously associated with the first device, with the second device comprises associating the computer implemented agent, which was previously associated with the first device, with the second device by the server in response to receipt of the message.

In some implementations, associating the computer implemented agent, which was previously associated with the first device, with the second device may include receiving, by the second device from the first device, a computer representation of the computer implemented agent and the first data, and executing, by the second device, the computer implemented agent. Receiving the computer representation of the computer implemented agent and the first data may include receiving the computer representation and the first data by the second device from the first device using near field communications. The method may include receiving, by the second device from the user, input indicating that the computer representation of the computer implemented agent should be transferred from the first device to the second device, receiving, by the second device from the first device, the computer representation of the computer implemented agent and the first data in response to the input indicating that the computer representation of the computer implemented agent should be transferred from the first device to the second device, and sending, by the second device to the first device, another computer representation of another computer implemented agent.

In some implementations, a computer representation of the computer implemented agent may include the first data. A computer representation of the computer implemented agent may include user history information that indicates user interactions with the first device and text to speech parameters for the computer implemented agent. A computer representation of the computer implemented agent may include device settings.

The subject matter described in this specification can be implemented in particular embodiments so as to realize one or more of the following advantages. In some implementations, transfer of device settings from an old device to a new device, e.g., with a computer-implemented agent, may reduce time spent by a user configuring the new device. In some implementations, transfer of custom commands from an old device to a new device, e.g., with a computer-implemented agent, may reduce time spent by the user configuring the new device. In some implementations, a computer-implemented agent may provide a user with device property differences between an old device and a new device so the user can learn the new features of the new device more quickly. In some implementations, only the device property differences determined by the computer-implemented agent to likely be most relevant to a user are presented to the user. In some implementations, a user is provided with audible or visible feedback indicating the association of a computer-implemented agent with a new device, e.g., to provide the user with a sense of the association of the computer-implemented agent from an old device to the new device.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-B show an example of an environment in which a new device receives a computer-implemented agent from an old device.

FIG. 2 is an example of a system in which an association of a computer implemented agent is changed from an old device to a new device.

FIG. 3 is a flow diagram of a process for providing a presentation of one or more property differences between two devices.

FIG. 4 is a block diagram of a computing system that can be used in connection with computer-implemented methods described in this document.

Like reference numbers and designations in the various drawings indicate like elements.

### DETAILED DESCRIPTION

### Overview

A user may customize a computer-implemented agent for her user device according to her preferences and/or the computer-implemented agent may learn some of the user's preferences from interactions with her. For instance, a conversational agent may learn data representing a user's accent or style of speech and use this data during voice interaction with the user. The user may customize settings for the conversational agent that include a particular style of speech, e.g., specific interactions the agent takes or ways the agent responds to particular situations with the user, a particular voice (e.g., sound of speech), a particular language, e.g., as text-to-speech parameters, custom commands, and/or other settings for the computer-implemented agent that are implicitly or explicitly defined by the user.

When the user gets a new user device, she would have to customize settings for a new computer-implemented agent included on the new user device, and in some instances may not be able to customize certain settings for the new computer-implemented agent, e.g., data learned by the old computer-implemented agent from interactions with the user. To reduce the number of settings the user must change for the new user device, the user may transfer her old computer-implemented agent to her new device. This allows the user to continue to interact with her old computer-implemented agent and maintains the settings of the computer-implemented agent, e.g., the user does not need to retrain or reset a new computer-implemented agent.

The transfer of the computer-implemented agent may include a transfer of some of the settings of the old user device. For instance, the computer-implemented agent may include wireless network settings that are transferred to the new user device and automatically configured by the computer-implemented agent on the new user device. In some examples, a user may create custom commands for the computer-implemented agent, such as “call my favorite uncle” or “launch my favorite game,” that may be transferred with the computer-implemented agent to the new device so that the agent will continue to respond appropriately to the user defined commands when the agent is associated with the new device.

The computer-implemented agent may also determine property differences between the old user device and the new user device and inform the user about some of those property differences. For instance, the computer-implemented agent may determine that a particular application installed on the old user device is not installed on the new user device and ask the user whether she would like the particular application installed on the new user device. The particular application may be an application that the user frequently uses. The computer-implemented agent may determine that the new user device provides the computer-implemented agent with additional functionality, such as improved voice recognition, a different type of microphone, or a particular sensor that was not included in the old user device, and inform the user about this additional functionality.

### Example Operating Environment

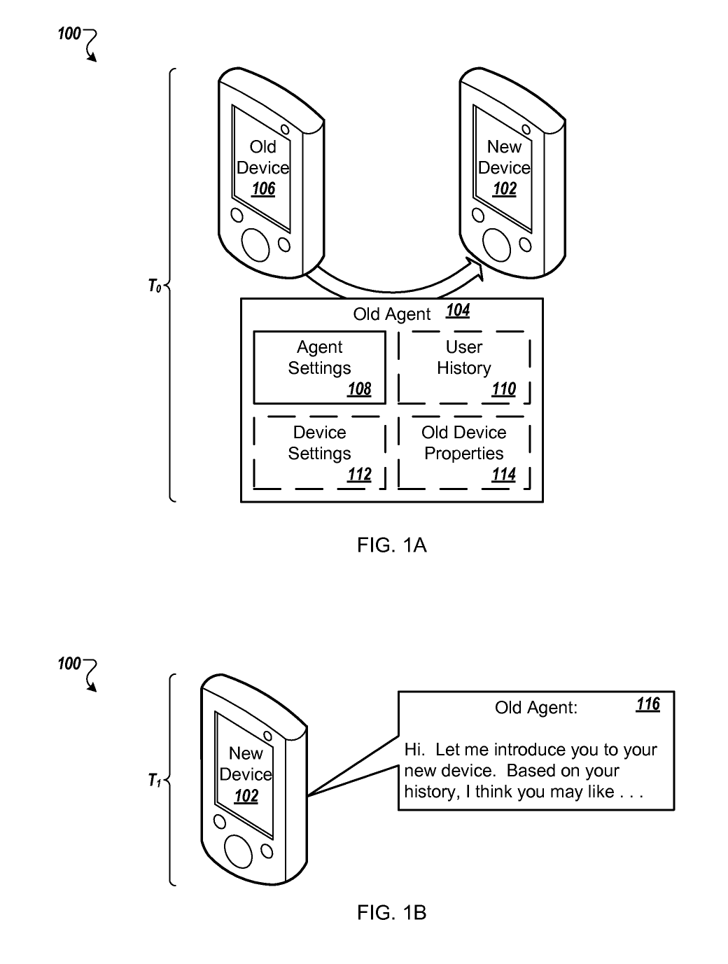

FIGS. 1A-B show an example of an environment 100 in which a new device 102 receives a computer-implemented old agent 104 from an old device 106. At T₀, the computer-implemented old agent 104 is transferred from the old device 106 to the new device 102, as shown in FIG. 1A. While the computer-implemented old agent 104 was associated with the old device 106, the old computer-implemented old agent 104 adapted to the preferences of a user who operated the old device 106, e.g., through interactions with the user or when the user explicitly adjusted a setting for the computer-implemented old agent 104. The old device 106 transfers the computer-implemented old agent 104 to the new device 102 in response to receipt of input from the user as described below in more detail. For instance, the old device 106 may use near field communications to transfer the computer-implemented old agent 104 to the new device 102.

The old device 106 may transfer the computer-implemented old agent 104 by sending data representing an application that embodies the computer-implemented old agent 104 and/or data representing agent settings 108 to the new device 102. The new device 102 receives the data representing the application and executes the application or updates the settings of an agent included on the new device 102 using the agent settings 108. The user of the new device 102 may have explicitly defined some of the settings of the computer-implemented old agent 104 and/or some of the settings of the computer-implemented old agent 104 may have changed over time, e.g., based on interaction between the computer-implemented old agent 104 and the user.

The transfer may include user history data 110 that identifies previous user interactions with the old device 106, such as contacts the user frequently calls, previous search queries, application use, etc. The computer-implemented old agent 104 may use the user history data 110 to determine what applications should be installed on the new device 102, whether new applications on the new device 102 are similar to applications on the old device 106 which the user frequently used, e.g., and may like, and/or to customize conversations with the user.

The computer-implemented old agent 104 may use device settings data 112 to update settings on the new device 102 to correspond to settings on the old device 106. The settings may include particular times and/or sounds for an alarm clock, contacts, ring tones, automatic power on and off settings, background settings, notification settings, etc.

When a device type of the old device 106 and the new device 102 is different, the computer-implemented old agent 104 may compare the device settings data 112 with settings of the new device 102 to determine which settings on the new device 102 correspond to settings on the old device 106. For instance, the name of a particular setting may be different but the computer-implemented old agent 104 may determine that the functionality of the setting is the same and that a particular option for the particular setting on the new device 102 is similar to one of the options for the old device 106.

The old device 106 may send old device property data 114 along with the data for the computer-implemented old agent 104 to the new device 102. When the computer-implemented old agent 104 executes on the new device 102, the computer-implemented old agent 104 may compare the old device property data 114 with properties of the new device 102 to determine differences between the properties. The differences may include different types of display screens, different sensors, e.g., a different compass or accelerometer, different applications or versions of applications, different services providers, e.g., for wireless or cellular networks, and/or new features, either hardware or software, available on the new device 102 which are different from the features of the old device 106 or were not available on the old device 106.

At T₁, the computer-implemented old agent 104 presents data describing some of the differences between the properties of the devices to the user. As shown in FIG. 1B, the computer-implemented old agent 104 provides voice output 116 to the user, e.g., using a speaker, stating: “Hi. Let me introduce you to your new device. Based on your history, I think you may like . . . ” The computer-implemented old agent 104 may then audibly and/or visually provide the user with a presentation of the differences between the properties, such as new applications the computer-implemented old agent 104 determines the user has a high probability of using or using frequently, or other features of the new device 102 the computer-implemented old agent 104 determined the user may like, e.g., using the user history data 110.

### Example System

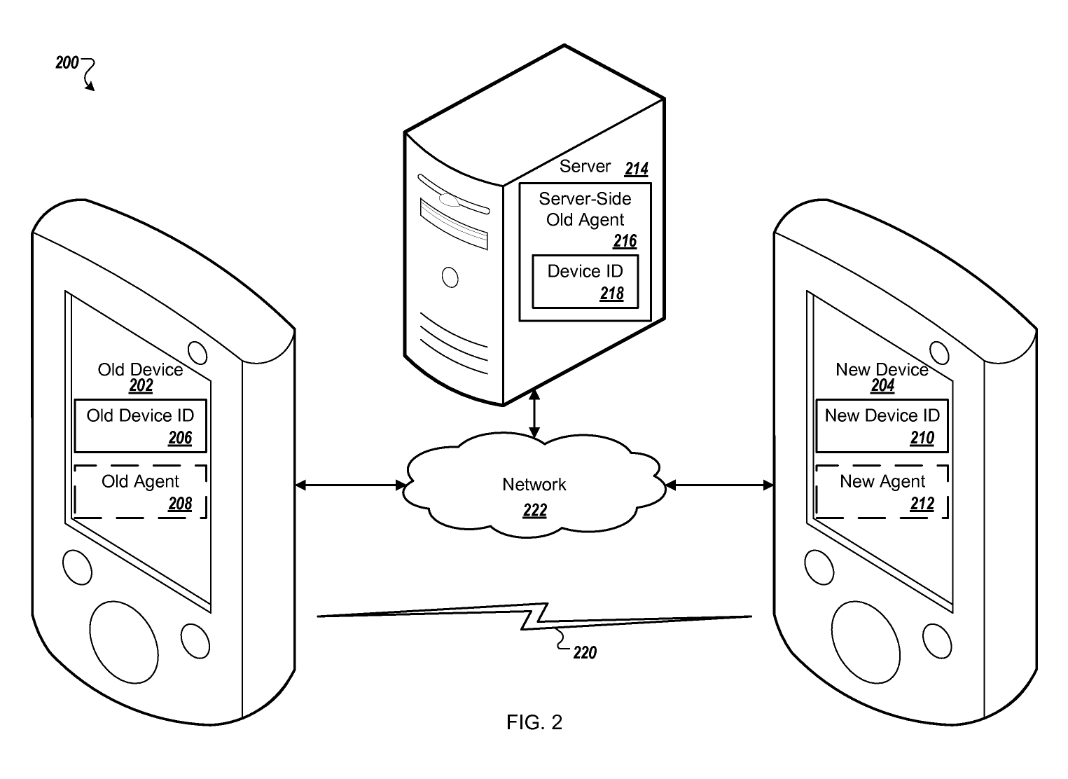

FIG. 2 is an example of a system 200 in which an association of a computer-implemented agent is changed from an old device 202 to a new device 204. A user, may place the old device 202 near the new device 204, e.g., after purchasing the new device 204, and ensure that both devices are on, e.g., by turning one or both devices on. The user may select an option on the new device 204 to provide input to the new device 204 that he wants the computer-implemented conversational agents of the old device 202 and the new device 204 to swap devices. For instance, the user may select a menu option or instruct a new agent 212, on the new device 204 that the new agent 212 should swap devices with an old agent 208, on the old device 202. The new device 204, or the new agent 212, may provide the user with an indication that the new agent 212 will be swapped with the old agent 208.

The new agent 212 may be swapped with the old agent 208 to ensure that each agent is associated with only one device. This allows the user to retain the settings of the old agent 208 while using the new device 204. The user may then provide the old device 202 to a friend or another person who can use the new agent 212 on the old device 202. The new agent 212 on the old device 202 may be an agent on the old device 202 with settings reset to default values or settings from the new agent 212 that was originally associated with the new device 204. In some examples, the old agent 208 is transferred to the new device 204 and the settings for the old agent 208 are removed from the old device 202, e.g., without swapping the two agents. In these examples, the old device 202 might not receive data for or be associated with the new agent 212 and might not have any agent. Regardless of the process used, the old agent 208 will only exist on one device after completion of the transfer of the old agent 208 to the new device 204.

The user selects a menu option on the old device 202 or interacts with the old agent 208 to provide input to the old device 202 that he wants to swap the agents. The old device 202 initiates a dialog with the new device 204 to begin a transfer of the old agent 208, the old agent, to the new device 204 from the old device 202. The transfer may include transfer of the new agent 212 from the new device 204 to the old device 202. In some implementations, the user may interact with the old device 202 prior to interacting with the new device 204 such that the new device initiates transfer of the agents.

The old device 202, or the new device 204 when the new device initiates the transfer, may use an audio signal, e.g., a high pitch audio signal, to ensure that the new device 204 is nearby and that the transfer is likely to be completed. In some examples, the old device 202 may use Bluetooth or any other appropriate technology to ensure that the new device is nearby.

The old device 202 may provide a message to a server 214 identifying the transfer of the old agent 208 to the new device 204. The message may include an identifier for the old agent 208 and another identifier for the new device 204, e.g., a new device identifier 210.

The server 214 uses the message to associate the old agent 208 with the new device 204. For instance, the old agent 208 may not execute entirely on the old device 202, and all of or part of the old agent 208 may execute on the server 214, as server-side old agent 216. In these implementations, the server 214 associates the server-side old agent 216 with the new device identifier 210, for instance by storing a device identifier 218 for the new device 204 with data for the server-side old agent 216. The data for the server-side old agent 216 may include a history for the agent and text-to-speech parameters, e.g., for the user.

During the transfer of the old agent 208 to the new device 204 or the association, on the server 214, of the old agent 208 with the new device 204, or upon completion of the transfer or association, the old device 202 and/or the new device 204 may provide audible or visible feedback to the user. For instance, the user may have a strong preference for the settings associated with the old agent 208, e.g., and prefer not customizing the user adjustable settings again when purchasing the new device 204. The audible or visible feedback upon completion of the transfer or association may provide the user with an indication that the transfer of the old agent 208 to the new device 204 completed successfully and that the user may then interact with the old agent 208 on the new device 204.

In some examples, the server 214 will associate an old device identifier 206 for the old device 202 with server-side data for the new agent 212. For example, when the user talks to the new device 204, the new device 204 sends a digital representation of the speech to the server 214 with the new device identifier 210 and the server 214 uses the new device identifier 210 to identify the server-side old agent 216 who responds to the user. When the user talks to the old device 202, the old device 202 sends a digital representation of the speech to the server 214 and the server uses the old device identifier 206 to identify the server-side new agent who responds to the user.

In some implementations, when one of the devices receives input from the user that is for the respective agent, the device sends an identifier for the respective agent to the server 214. For example, instead of sending the new device identifier 210 to the server 214, the new device 204 sends an identifier for the old agent, after the old agent is associated with the new device 204, and the server uses that identifier for the old agent to determine the agent, e.g., the server-side old agent 216, to use when responding to the user.

The devices may send only the identifier, e.g., of the device or the respective agent, instead of sending both the identifier and a digital representation of speech. In these examples, the server may execute the agent and provide an interface for the agent that interacts with the respective device and receives input from the respective device, e.g., a digital representation of speech.

In other implementations, the agents are executed in whole or in part on the respective device. For instance, the data for the agent may be stored on the devices instead of or in addition to on the server 214. In these implementations, the old device 202 may transfer the old agent 208 to the new device 204 using near field communications 220. The old device 202 may send data representing the history of the computer-implemented old agent 208, text-to-speech parameters, e.g., for the user and potentially other users of the old device 202, and other data for the old agent 208 to the new device 204. When the old device 202 directly transfers the data for the computer-implemented old agent 208 to the new device 204, the old device 202 or the new device 204 may update an association of the old agent 208, on the server 214, to the new device 204.

Once the old agent 208 is associated with the new device 204, the old agent 208 may compare properties of the old device 202 with properties of the new device 204 to determine differences between the properties and present the user with information about the differences between the properties. The properties may be hardware or software properties, such as a display, processor, memory, sensor, setting, or application property. The properties may be general properties, such as a memory type, processor type, or application name, or specific properties, such a size or a speed of the memory, a speed of the processor, or a version of the application.

The old agent 208 may use additional data, e.g., from a database, when presenting information about the differences. For instance, when the old agent 208 determines that a hard drive on the new device 204 is larger than the hard drive on the old device 202 and the old agent 208 may determine that the user typically stores songs and photos on the hard drive, determine how many additional songs and/or photos the user can store on the new device 204, and present this information to the user. The old agent 208 may tell the user: “Hi, the hard drive on your new device is a lot larger. You can hold ten times as many photos and songs as you could on your old device.” The old agent 208 may use any appropriate additional data, such as a database on the server 214 or a database on another computer, e.g., that hosts a part of a website, to determine how the differences between the properties may affect, e.g., benefit, the user.

The devices 202 and 204 may include personal computers, mobile communication devices, and other devices that can send and receive data over a network 222. The network 222, such as a local area network (LAN), wide area network (WAN), the Internet, or a combination thereof, connects the devices 202 and 204 and the server 214.

### Example Process Flow

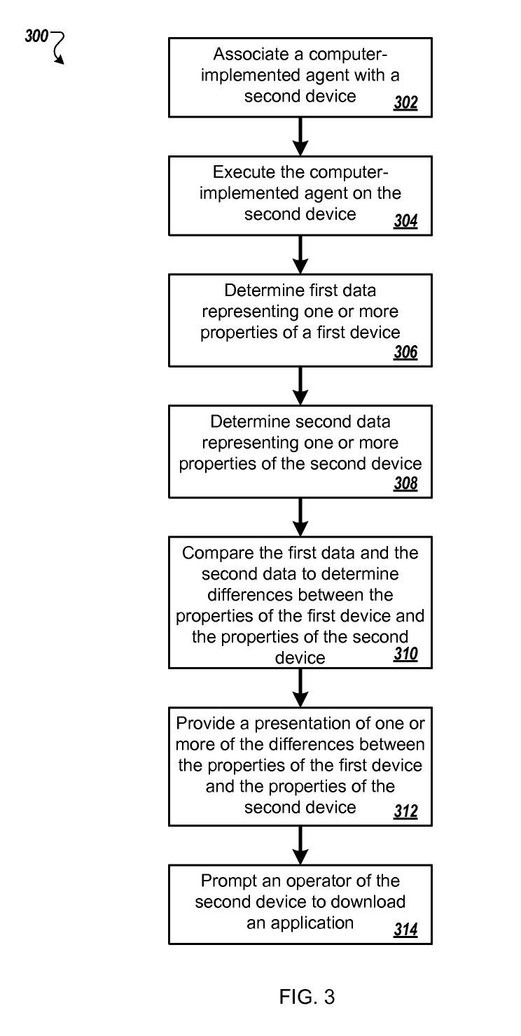

FIG. 3 is a flow diagram of a process 300 for providing a presentation of one or more property differences between two devices. For example, the process 300 can be used by the new device 102 from the environment 100.

The process associates a computer-implemented agent with a second device (302). For instance, the second device receives data representing the computer-implemented agent from a first device or a server, or a server associates data for the computer-implemented agent with the second device, e.g., with an identifier of the second device.

The process executes the computer-implemented agent on the second device (304). The second device uses the data representing the computer-implemented agent to update a profile for the computer-implemented agent that is stored on the second device and executes the computer-implemented agent. In some examples, the second device sends a message to the server requesting that the server execute the computer-implemented agent, e.g., entirely on the server or partially on the server and partially on the second device.

The process determines first data representing one or more properties of a first device (306). The second device may receive the first data with the data representing the computer-implemented agent, e.g., received from the first device. In some examples, the second device receives the first data from a server or from a web site that identifies properties of the first device.

The process determines second data representing one or more properties of the second device (308). The computer-implemented agent may determine the properties of the second device or may receive input representing the properties of the second device, e.g., from a web site that identifies the properties of the second device.

The process compares the first data and the second data to determine differences between the properties of the first device and the properties of the second device (310). The computer-implemented agent compares the first data and the second data to determine the different properties between the two devices.

The computer-implemented agent may determine a probability that a particular property difference is relevant to an operator of the second device. For instance, the computer-implemented agent may determine a probability that the operator would use a particular application that was installed on the first device and is not installed on the second device. The computer-implemented agent may determine the probability using an operator profile or operator history data that indicates the applications or types of applications the operator used. The probability may represent a quantity of times the operator launched the particular application, or a group of related applications, e.g., provided by a single publisher, compared to a quantity of times the operator launched any of the applications installed on the first device. The computer-implemented agent may determine the probability using a quantity of times the operator launched the particular application or a duration for which the operator interacted, e.g., visually or audibly, with the particular application compared to a predetermined value. When the predetermined value is five times a day, and the operator interacted with the particular application seven times a day, the probability may be high to indicate that the operator is likely to use the particular application if the particular application were installed on the second device. When the predetermined value is five times a day, and the operator interacted with the particular application only once or twice a day, or on average less than once a day, the probability may be low to indicate that the operator is not very likely to use the particular application if the particular application were installed on the second device.

If the probability satisfies a threshold value, the computer-implemented agent may determine that information about the application should be presented to the operator, e.g., and not to present information about other property differences that do not satisfy another threshold values or have corresponding probabilities that satisfy the threshold value or another threshold value.

In some examples, the computer-implemented agent may have different threshold values for different types of properties and differences between the properties. For example, when the computer-implemented agent determines that the there is a fifty percent probability that the operator will use an application, the computer-implemented agent may determine to present information about the application difference to the operator, e.g., different version or installed versus not installed. When the computer-implemented agent determines that a change in a screen resolution is less than a resolution difference threshold value, the computer-implemented agent may not present information about the change in the screen resolution size to the operator. But if the change to the screen resolution were equal to or greater than the resolution difference threshold value, the computer-implemented agent may present information about the change in the screen resolution size to the operator.

The process provides a presentation of one or more of the differences between the properties of the first device and the properties of the second device (312). For instance, the computer-implemented agent provides a verbal or visual presentation describing the property differences. The type of presentation may depend on a type of the difference. A difference in screen type or resolution size may be presented visually, differences between versions of an application may be presented visually, e.g., if there are changes to a user interface, or verbally, e.g., if there is a change to a high level process flow or application use, and another difference may be presented both visually and verbally, e.g., when the computer-implemented agent describes new settings available on the second device.

The presentation may include a presentation of multiple differences and/or multiple aspects of the second device. The computer-implemented agent may walk the operator through multiple user interfaces of an application to present changes to the user interfaces or a process of the application to the operator. For instance, the computer-implemented agent may use a script to provide a walkthrough of the user interfaces to the user. The script may be retrieved from a server, e.g., maintained by a publisher of the application or another entity. The computer-implemented agent may present information about multiple different applications, settings, and/or features of the second device to the operator, showing corresponding differences for each of the applications, settings, and/or features.

The process prompts an operator of the second device to download an application (314). For example, when the computer-implemented agent determines that a probability of the operator using a particular application that was installed on the first device and is not installed on the second device satisfies a threshold value, the computer-implemented agent may ask the operator whether the operator the application installed on the second device. For instance, as indicated above, the probability may be determined using a quantity of times the operator launched or opened an application, e.g., during a predetermined period of time, such as a day, a week, or a month, or an average duration during which the operator interacted with the application, e.g., during another predetermined period of time. The probability may be determined using only the quantity or duration of the application or may be determined using a quantity or duration for other applications, e.g., and be based on the percent of times the application was opened compared to the opening of any application or the percent of the duration with which the operator interacted with the application, visually or audibly, compared to the total duration with which the operator interacted with the first device. In some examples, the computer-implemented agent may automatically, without operator input or instructions to install a particular application, install the particular application, e.g., when the operator configured the computer-implemented to automatically install applications determined likely to be used by the operator.

The order of steps in the process 300 described above is illustrative only, and providing a presentation of one or more property differences between two devices can be performed in different orders. For example, the computer-implemented agent may determine the second data, e.g., perform step 308, and then retrieve the first data from member or a server, e.g., perform step 306.

In some implementations, the process 300 can include additional steps, fewer steps, or some of the steps can be divided into multiple steps. For example, the process may associate the computer-implemented with the second device, execute the computer-implemented agent on the second device, and provide the presentation of the differences between the properties, e.g., steps 302, 304, and 312, without performing the other steps in the process 300. In this example, a server may determine the first and second data and the differences between the properties of the first and second devices and provide the computer-implemented agent with information representing the differences between the properties. The first device may provide the first data to the server and the second device may provide the second data to the server. In some examples, the second device may provide both the first data and the second data to the server.

### Optional Implementation Details

In some implementations, a server may facilitate transfer of a computer-implemented agent from a first device to a second device. The server may receive input from the first device indicating that the computer-implemented agent should be transferred to the second device and confirmation of the transfer from the second device. The server may then receive data representing the computer-implemented agent, e.g., an agent history and/or text-to-speech parameters, and send the data to the second device.

The server may initiate the transfer of the computer-implemented agent between two devices that are near each other, e.g., within thirty, fifty, or one-hundred feet, or between two devices that are at discrete locations, e.g., in a building, a city, a state, a country, or the world. The transfer may be from a device a user forgot in one city to another device the user currently has with him. For instance, a friend of the user may initiate the transfer on the device and the user may accept the transfer using the other device.

In some implementations, the computer-implemented agent is only associated with one device. A system may prevent the association of the computer-implemented agent with multiple devices to retain an impression of the computer-implemented agent as a distinct entity, e.g., associated with only one particular device.

In some implementations, a second device may receive device settings from a first device and a server may associate a computer-implemented agent with the second device. For instance, some data associated with a user who previously operated the first device and now operates the second device is received by the second device from the first device and the server updates an identifier for the computer-implemented agent to indicate that the computer-implemented agent is now associated with the second device.

In some implementations, the devices with which a new agent and an old agent are associated are swapped. In some implementations, the old agent is associated with a new device, e.g., and the new agent is not associated with any device or is deleted.

### Additional Implementation Details

In situations in which the systems discussed here collect personal information about users, or may make use of personal information, the users may be provided with an opportunity to control whether programs or features collect user information (e.g., information about a user's preferences, text-to-speech parameters, or a user's conversational history with a computer-implemented agent), or to control whether and/or how to receive content from the computer-implemented agent that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

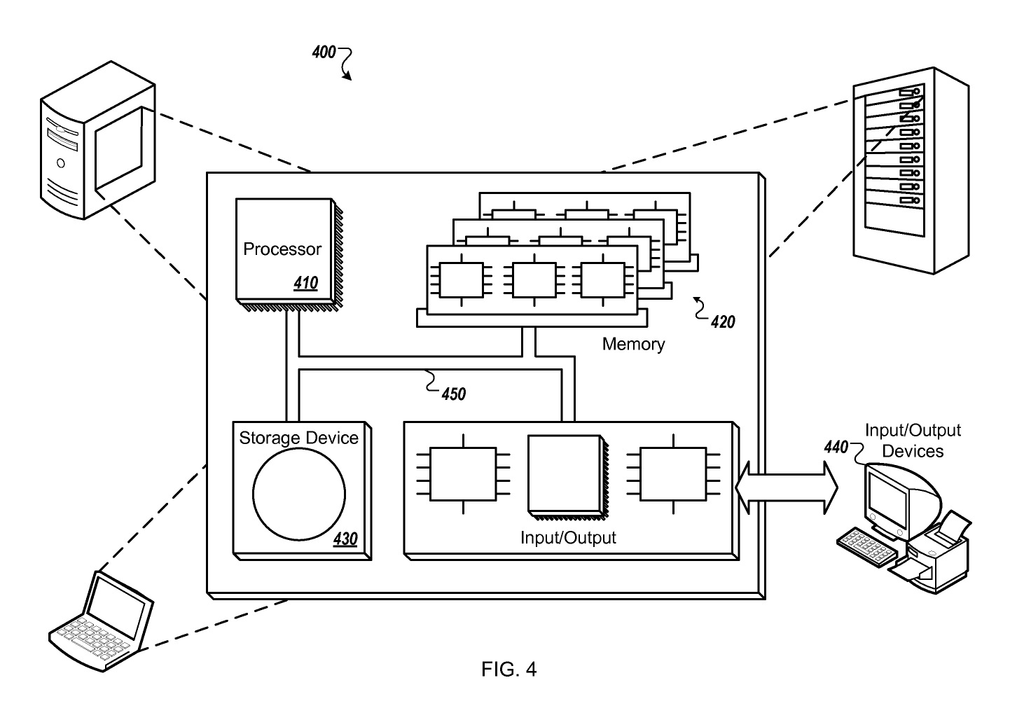

An example of one such type of computer is shown in FIG. 4, which shows a schematic diagram of a generic computer system 400. The system 400 can be used for the operations described in association with any of the computer-implement methods described previously, according to one implementation. The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
associating a computer-implemented agent, which was previously associated with a first device, with a second device;
determining, by the computer-implemented agent, first data representing one or more properties of the first device;
determining, by the computer-implemented agent, second data representing one or more properties of the second device;
comparing, by the computer implemented agent, the first data and the second data to determine differences between the properties of the first device and the properties of the second device; and
providing, by the computer-implemented agent to a user of the second device, a presentation of one or more of the differences between the properties of the first device and the properties of the second device.

2. The method of claim 1 wherein:
a computer representation of the computer-implemented agent comprises user history information that indicates user interactions with the first device; and
comparing the first data and the second data to determine the differences between the properties of the first device and the properties of the second device comprises:
determining, using the user history information, the properties of the second device that are different from the properties of the first device and that are most likely to be used by the user of the second device; and
providing, by the computer-implemented agent to the user of the second device, a presentation of the properties of the second device that are different from the properties of the first device and that are most likely to be used by the user.

3. The method of claim 2 comprising prompting, by the computer-implemented agent, the user of the second device to download an application in response to determining the properties of the second device that are different from the properties of the first device and that are most likely to be used by the user of the second device.

4. The method of claim 1 wherein comparing the first data and the second data to determine the differences between the properties of the first device and the properties of the second device comprises comparing the first data and the second data to determine hardware differences between the first device and the second device.

5. The method of claim 1 wherein comparing the first data and the second data to determine the differences between the properties of the first device and the properties of the second device comprises comparing the first data and the second data to determine applications or settings available on the second device that were not available on the first device.

6. The method of claim 1 wherein comparing the first data and the second data to determine the differences between the properties of the first device and the properties of the second device comprises comparing the first data and the second data to determine different functionality available to the computer-implemented agent when associated with the second device that was not available to the computer-implemented agent when the computer-implemented agent was associated with the first device.

7. The method of claim 1 wherein:
associating the computer-implemented agent, which was previously associated with the first device, with the second device comprises changing, by a server, an assignment of the computer-implemented agent from the first device to the second device; and
executing, by the server, the computer-implemented agent after the computer-implemented agent is associated with the second device.

8. The method of claim 7 comprising:
receiving, by the server prior to associating the computer-implemented agent with the second device, a message from the first device that identifies the first device and the second device and indicates that the server should associate the computer-implemented agent with the second device, wherein associating the computer-implemented agent, which was previously associated with the first device, with the second device comprises associating the computer-implemented agent, which was previously associated with the first device, with the second device by the server in response to receipt of the message.

9. The method of claim 1 wherein:
associating the computer-implemented agent, which was previously associated with the first device, with the second device comprises receiving, by the second device from the first device, a computer representation of the computer-implemented agent and the first data; and
executing, by the second device, the computer-implemented agent.

10. The method of claim 9 wherein receiving the computer representation of the computer-implemented agent and the first data comprises receiving the computer representation and the first data by the second device from the first device using near field communications.

11. The method of claim 9 comprising:
receiving, by the second device from the user, input indicating that the computer representation of the computer-implemented agent should be transferred from the first device to the second device;
receiving, by the second device from the first device, the computer representation of the computer-implemented agent and the first data in response to the input indicating that the computer representation of the computer-implemented agent should be transferred from the first device to the second device; and
sending, by the second device to the first device, another computer representation of another computer-implemented agent.

12. The method of claim 1 wherein a computer representation of the computer-implemented agent comprises the first data.

13. The method of claim 1 wherein a computer representation of the computer-implemented agent comprises user history information that indicates user interactions with the first device and text-to-speech parameters for the computer-implemented agent.

14. The method of claim 1 wherein a computer representation of the computer-implemented agent comprises device settings.

15. A system, comprising:
a data processing apparatus; and
a non-transitory computer readable storage medium in data communication with the data processing apparatus and storing instructions executable by the data processing apparatus and upon such execution cause the data processing to perform operations comprising:
associating a computer-implemented agent, which was previously associated with a first device, with a second device;
determining, by the computer-implemented agent, first data representing one or more properties of the first device;
determining, by the computer-implemented agent, second data representing one or more properties of the second device;
comparing, by the computer implemented agent, the first data and the second data to determine differences between the properties of the first device and the properties of the second device; and
providing, by the computer-implemented agent to a user of the second device, a presentation of one or more of the differences between the properties of the first device and the properties of the second device.

16. The method of claim 15 wherein:
a computer representation of the computer-implemented agent comprises user history information that indicates user interactions with the first device; and
comparing the first data and the second data to determine the differences between the properties of the first device and the properties of the second device comprises:
determining, using the user history information, the properties of the second device that are different from the properties of the first device and that are most likely to be used by the user of the second device; and
providing, by the computer-implemented agent to the user of the second device, a presentation of the properties of the second device that are different from the properties of the first device and that are most likely to be used by the user.

17. The method of claim 15 wherein comparing the first data and the second data to determine the differences between the properties of the first device and the properties of the second device comprises comparing the first data and the second data to determine hardware differences between the first device and the second device.

18. The method of claim 15 wherein comparing the first data and the second data to determine the differences between the properties of the first device and the properties of the second device comprises comparing the first data and the second data to determine applications or settings available on the second device that were not available on the first device.

19. The method of claim 15 wherein comparing the first data and the second data to determine the differences between the properties of the first device and the properties of the second device comprises comparing the first data and the second data to determine different functionality available to the computer-implemented agent when associated with the second device that was not available to the computer-implemented agent when the computer-implemented agent was associated with the first device.

20. A non-transitory computer readable storage medium storing instructions executable by a data processing apparatus and upon such execution cause the data processing to perform operations comprising:
associating a computer-implemented agent, which was previously associated with a first device, with a second device;
determining, by the computer-implemented agent, first data representing one or more properties of the first device;
determining, by the computer-implemented agent, second data representing one or more properties of the second device;
comparing, by the computer implemented agent, the first data and the second data to determine differences between the properties of the first device and the properties of the second device; and
providing, by the computer-implemented agent to a user of the second device, a presentation of one or more of the differences between the properties of the first device and the properties of the second device.
